(19) United States
(12) Patent Application Publication
(10) Pub. No.: US 2002/0155187 A1
(43) Pub. Date: Oct. 24, 2002

(54) Apparatus for manufacturing multi-color slide fastener

(76) Inventor: Young-chul Kang, Yongin-Si (KR)

Correspondence Address: ROTH & GOLDMAN, P.A., 523 W. 6TH STREET, SUITE 707, LOS ANGELES, CA, 90014, US

(21) Appl. No.: 09/902,207

(22) Filed: Jul. 9, 2001

(30) Foreign Application Priority Data
Apr. 20, 2001 (KR) 2001-21368

(51) Int. Cl. B29C 45/14; B29C 70/74

(52) U.S. Cl. 425/121; 425/129.1; 425/545; 425/582

(57) ABSTRACT

An apparatus for manufacturing a multi-color slide fastener is disclosed, in which a plurality of unit meshing teeth are coupled to a pair of supporting tapes so as to be slide-coupled or separated. The plurality of the unit meshing teeth are made to have diversified colors, and the patterns of the unit meshing teeth are continuously harmonized with the patterns of the base fabric of a garment. A plurality of groups of the meshing teeth are formed with different colors by one shot, so that the meshing teeth could form various patterns. Therefore, the pitches and gaps between the unit meshing teeth are uniform. Accordingly, not only the multi-color slide fasteners can be mass-produced, but also their quality and reliability can be upgraded. Further, various patterns and colors can be formed on the slide fastener. Further, when the multi-color slide fastener is installed to a garment or the like, any discontinuity of the pattern can be eliminated, and therefore, the aesthetics can be improved when installed in garments, bags and other personal articles. If this multi-color slide fastener is used in garments, bags, athletic uniforms, skiing uniforms, personal articles and the like, then such an expansion of application will create the demand, and will satisfy the consumer trend. Thus the multi-color slide fastener manufacturing apparatus is capable of manufacturing the multi-color slide fastener in a practical and satisfactory manner. Its production is not only fast but also its pitches are uniform, while the product defects are eliminated. Further, the liberty degree is profusely allowed in the design.

### FIELD OF THE INVENTION

The present invention relates to an apparatus for manufacturing a multi-color slide fastener. Particularly, the present invention relates to an apparatus for manufacturing a multi-color slide fastener, in which a plurality of unit meshing teeth are coupled to a pair of supporting tapes so as to be side-coupled or separated, the plurality of the unit meshing teeth are made to have diversified colors, and the patterns of the unit meshing teeth are continuously harmonized with the patterns of the base fabric of a garment.

### BACKGROUND OF THE INVENTION

Generally, slide fasteners are widely used in garments and bags. The slide fasteners are constituted such that a plurality of unit meshing teeth are attached on a pair of supporting tapes in the lengthwise direction so as to be coupled or separated by a slider. Accordingly, the slide fasteners are used for opening or closing the products such as garments and bags.

In these slide fasteners, the supporting tapes are usually made of a fabric, and the unit meshing teeth and the slider are made of a synthetic resin or a metal. Further, the unit meshing teeth, the slider and the supporting tapes have a single pattern and a single color, and the pattern of them are significantly different from that of the garment, with the result that a pattern discontinuity is formed.

Accordingly, the slide fasteners cannot be harmonized with the garments, the bags and the personal articles, and therefore, the equilibrium is failed in the design. Therefore, diversified and colorful fashions cannot be realized, and the individuality is lost, while the design impression is damaged. Further, the liberty degree of the design is restricted.

In an attempt to solve the problems of the single color slide fasteners, Japanese Patent Publication No. Sho-61-293822 and Korean Patent Publication No. 1990-0001907 (to be called “cited inventions” below) respectively disclose a new method for manufacturing a slide fastener stringer.

In this method for manufacturing the slide fattener stringer, a stringer tape is involved, and there are also formed multi-color injection-molded element trains that are attached on the stringer tape in the longitudinal direction. This method includes the steps of: (a) injection-molding a plurality of longitudinally separated coupling element trains on a stringer tape in the longitudinal direction, the injection-molded coupling element trains having a first color and being separated from each other by non-element portions; (b) injection-molding a plurality of longitudinally separated coupling element trains on a stringer tape along the non-element portions, these newly injection-molded coupling element trains having a second color different from the first color of the previously injection-molded coupling element trains; and (c) repeatedly carrying out the step (b) until the non-element portions are filled with the injection-molded coupling elements

The injection-molding step (a) of the method includes the sub-steps of: (a-1) introducing a stringer tape into between relatively movable molding die members, the molding die members forming a molding cavity; (a-2) injecting a colored melted synthetic resin when the molding die members are completely closed; (a-3) longitudinally feeding the stringer tape until the rear end of the coupling element train (injection-molded just now) is separated from the leading end of the molding cavity as much as an integer-multiple of the length of the coupling element train (injection-molded just now); and (a-4) repeatedly carrying out the sub-steps (a-2) and (a-3).

This conventional slide fastener stringer manufacturing method will be summarized. The running path of the molding die for molding the general slide fastener, which is usually 250 mm to 700 mm, is divided e.g., into ten equi-distant portions. By using this specially prepared molding die, first one-tenth of the element of the first color is injection-molded on the stringer tape.

Then the upper and lower dies are completely opened, and then, the stringer tape is fed as much as an integer-multiple of the length of the injection-molded elements (injection-molded just now). Then, the elements of a second color are injection-molded as much as one-tenth. Then other color is injection-molded as much as one-tenth, and this procedure is repeatedly carried out, thereby manufacturing a multi-color slide fastener.

In connection with the above described manufacturing method, an individual slide fastener, i.e., a commodity slide fastener which can be used in an adult garment or the like will be criticized.

For example, a slide fastener will be examined in which the total length is 500 mm, the pitch of the elements is 2 mm, and the number of the elements is 250.

At a first process, five elements are injection-molded with a certain color, then the injection-molded elements are cooled, and then the stringer tape is fed further. At a second process, another five elements are injection-molded with another color, then the injection-molded elements are cooled, and then the stringer tape is fed still further. These processes are repeated 50 times to manufactured one slide fastener.

Accordingly, there are serious problems in this method. That is, in order to manufacture one single slide fastener, the process of injection-molding, cooling and feeding has to be carried out 50 times. During the cooling, there are accompanied contractions and deformations, while during the feeding, the dislocation errors are increased. As a result, the pitch distance cannot be uniform between the element groups that have been injection-molded at different stages.

Thus in the above described method, in manufacturing a single slide fastener, the process of injection-molding, cooling and feeding has to be carried out several-score times repeatedly. Thus the thermal contractions and dislocations occur several-score times, and therefore, the pitches of the unit meshing teeth cannot be uniform.

Further, the gaps between the teeth over the different processes are not constant, and therefore, a practically useful fastener cannot be realized.

FIG. 1 is a longitudinal sectional view showing the general apparatus for manufacturing a single color slide fastener As shown in this drawing, an upper die 110 is coupled to a movable block, while a lower die 120 is coupled to a fixed block. Further, a driving roll R1 and a pinch roll R2 feed a supporting tape 1 into the die 100 (110 and 120), and the upper die 110 is provided with an injection cylinder C for heating the synthetic resin and for injecting it.

Although there are no illustrations, at the inlet side of the die 100, there are included: a foreign material sensing part for detecting any foreign materials on the supporting tape 1 and for detecting the joining parts of the supporting tape 1 to stop the operation of the apparatus; a tension control part for controlling the tension of the supporting tape at the inlet; and a position setting part for setting the position of the supporting tape 1 before the supporting tape enters into the die 100 so as to make unit meshing teeth 2 molded to the correct positions.

At the outlet side of the die 100, there are included: a tension control part for controlling the tension of the supporting tape 1 at the outlet side of the die 100; and a slider coupling part for coupling a slider to the injection-molded unit meshing teeth 2.

Further, in this apparatus, the supporting tape 1 is carried by the driving roll R1 and the pinch roll R2, while the runner in which the meshing teeth are injection-molded is cut off by a cutter, the cutter being provided on the driving roll R1. However, in another apparatus that is not illustrated, the cutter is provided separately from the carrying devices.

In this general slide fastener manufacturing apparatus, the supporting tape 1 is continuously supplied by being guided by the guide roller of the inlet side of the die 100. A synthetic resin is continuously supplied through a hopper H into the cylinder C, so that the synthetic resin can be heated and injected through an injection nozzle 20.

If the supporting tape 1 arrives at the injection-molding position by being driven by the driving roll R1 and by the pinch roll R2, then the carriage is stopped. Then the upper die 110 descends to be coupled to the lower die 120, and the melted synthetic resin is injected from the cylinder C through the injection nozzle 20 into the cavity of the die 100.

Thus when one injection-molding, i.e., one-shot is completed, the driving roll R1 and the pinch roll R2 are activated to carry the supporting tape 1 forward, and the runner and the unit meshing teeth 2 are cut off by the cutter of the driving roll R1, so that the supporting tape 1 with the unit meshing teeth 2 formed thereon are stacked into a collecting vessel. The runner is put into a crusher to be crushed there to be supplied again into the hopper H.

In the slide fastener thus manufactured, the one-shot length by the die 100 is about 250˜500 mm, and the pitch length of the unit meshing teeth is about 2˜3.5 mm, so as to form 70 of the unit meshing teeth 2 at one time. This manufacturing process is repeatedly carried out over about 300 m of a raw cloth.

The quality of this slide fastener is decided by the uniformity of the pitch gaps and shape of the unit meshing teeth. This quality can be realized by precisely selecting and setting the raw cloth quality, the raw cloth advancing velocity, the injecting-molding pressure, the injection-molding speed, the cooling time, the ejecting time and the like. A precise adjustment of the operating conditions of the apparatus is very fastidious and difficult.

When the raw cloth is exhausted, if a same raw cloth is to be supplied, the operation can be carried out without any readjustment of the operating conditions. However, if a raw cloth that is different in the elongation, unit weight and volume is to be fed, the fastidious operating conditions have to be readjusted.

Accordingly, at a slide fastener manufacturing factory, once the operation of the apparatus starts, the operation is continued without stop while continuously supplying the raw cloth rolls as long as a power failure or the like does not occur. When new raw cloth rolls are supplied, if the characteristics of the raw cloth are same, then the operating conditions of the apparatus can be maintained without change.

Thus as shown in FIG. 2, a raw cloth of 250 mm˜700 mm is coupled to the die. Then as shown in FIG. 3, the meshing teeth are simultaneously formed to a number of 70˜150, the shape of the meshing teeth being same as those, which are formed in the die. Thus the pitch can be made precisely same as that of the cavity of the die.

However, if the raw cloth and the synthetic resin are changed frequently, not only the production speed is slowed, but also the operating conditions have to be adjusted, with the result that the product quality is degraded, with the result that the competitive power is lowered.

In the general slide fastener manufacturing process, there is used the die in which a cavity is formed to mold a long element train of 250 mm 50 700 mm. However, the multi-color slide fastener manufacturing method of the cited invention is carried out in the following manner.

That is, in the cited invention, the cavity is reduced to about one-several-scoreth, e.g., about one-tenth. That is, such a specially prepared die is used for manufacturing the multi-color slide fastener.

That is, as shown in FIG. 4a, elements of a first color are injection-molded on the stringer tape as much as one-tenth. Then the upper and lower dies are completely opened, and the stringer tape is made to advance as much as an integer multiple of the length of the element train that has been just formed.

Then as shown in FIG. 4b, elements of a second color are injection-molded over a one-tenth length. Then as shown in FIGS. 4c to 4g, the operation is repeatedly carried out using other colors, over a length of one-tenth each time, thereby completing the multi-color slide fastener as shown in FIG. 4g.

However, the cited invention is no more than an impractical invention due to the problems described below

That is, in the general slide fastener-manufacturing apparatus, the injection molding is carried out simultaneously over a running path length of 250 mm to 700 mm, and therefore, the meshing teeth are formed as much as 70 to 150 at one time. In contrast to this, in the cited invention, the same quantity of the meshing teeth can be injection-molded by repeatedly carrying out the operation as many times as 20 to 100. Therefore, in principle, the cited invention is impractical.

Further, in general, the pitch length is 2˜3.5 mm, and for example, if the pitch length is decided to be 2 mm, then the 70 to 250 meshing teeth have exactly the same pitch length of 2 mm. Thus only when the pitch length is precisely maintained, the product can become practically usable.

However, in the cited invention, there is no description on the method of precisely maintaining the pitch length. Further, there has to be necessarily equipped a device which is capable of making the stringer tape advance exactly as much as an integer multiple of the initially injection-molded length.

In spite of this fact, the cited invention only mentions on a position holding member, which is said to carry the rear end of the element train by a certain length in the longitudinal direction. However, there is no description as to how the position holding member is constituted. This position-holding member is an important one, and is not obvious. Therefore, its constitution should be specifically described, and otherwise, the cited invention becomes impractical.

When a slide fastener is injection-molded, then product is contracted and deformed, and therefore, the pitch of the meshing teeth becomes irregular. For example, the error gap d increases as coming to both of the outsides from the sprue. Thus if the meshing teeth which have been contracted and deformed are put to the die many times to be subjected to injection-molding, then the errors due to the contraction and deformation and the errors due to the position setting are overlapped together As a result, the meshing teeth are irregularly formed as shown in FIG. 5b.

Accordingly, the pitches of the meshing teeth cannot be constant, and further, when closing the upper and lower dies together, the unit meshing teeth are damaged by the dies, with the result that the unit meshing teeth cannot have a uniform shape.

Further, after separating the sprue and the runner and the gate stick in the product in which the respective meshing teeth are irregularly formed as shown in FIG. 5b, if the meshing teeth are coupled as shown in FIG. 5c, then the positions of some of the meshing teeth are incorrectly placed as shown by d in FIG. 5. Accordingly, the incorrectly positioned meshing teeth are overlapped as shown by s, with the result that the product cannot be used as a slide fastener.

Further, as to the manufacturing method for the slide fastener stringer, a control rod is inserted into the running path of the die so as to adjust the length of the element trains which are to be injection-molded. However, in the running path of the die, there is injected the melted resin at a high pressure, and the pitch gaps have to be precise to such a degree that the error range should be approximately 0.

Therefore, the description that the length of the element train is adjusted by inserting the control rod is an impractical idea. If the control rod is actually to be inserted so as to block the flow of the melted resin, then the constitution of the control rod should be described in detail, but there is no such a description in the slide fastener stringer manufacturing method of the cited invention.

Further, in the stringer manufacturing method, the meshing teeth train is injection-molded with one color as much as one-tenth or so of the total length, and another one-tenth or so is injection-molded with another color, these processes being repeatedly carried out several score times. If this is to be done with different colors, then at each process, the die has to be opened, and its inside has to be cleanly wiped with rags to remove the resin of the different color before carrying out the next process.

In order to manufacture a slide fastener of 250 mm to 700 mm with the meshing teeth of various colors, if the insides of the die and the cylinder are to be cleanly wiped to remove the resin at each process step, it will be too much troublesome, as well as causing the loss of materials. Further, the cleaning has to be accompanied by the stop of the operation of the apparatus, with the result that the time squandering will be enormous, and the productivity will be greatly lowered. In view of this, the method of the cited invention is utterly unrealistic.

Further, in the slide fastener stringer manufacturing method of the cited invention, when manufacturing a single slide fastener, there have to be repeatedly carried out the injection-molding, the cooling and the carrying for several-score times, and therefore, contraction-deformation-position-shifts are undergone for several-score times. Consequently, the pitches and gaps of the meshing teeth become irregular.

Accordingly, this method cannot be applied to the conventional automatic slide fastener manufacturing apparatus. If the method is to be put to the practical use, new devices have to be provided. However, in the description of the cited invention, there is no such device, and therefore, the method is actually impractical.

FIG. 6 illustrates the problems that occur in the conventional single color slide fastener pattern.

In the case where the conventional slide fastener is attached on a garment, the supporting tapes 1 and the patterns 1′ and 2′ of the meshing teeth of the slide fastener are markedly different from the base fabric of the garment 4. Therefore, there is formed a discontinuity part 5 between the base fabric 4 of the garment and the slide fastener, with the result that the design aesthetics is aggravated. However, the cited invention which has been proposed to overcome the conventional disadvantages is unrealistic and impractical.

Therefore, the present inventor has been making efforts to devise an apparatus that is capable of speedily manufacturing the multi-color slide fasteners with the mechanism of the conventional apparatus.

As a result, the present inventor could invent a method and an apparatus, which could overcome the conventional disadvantages. This technique was applied to obtain a patent, and was patented under Patent Publication No. 1999-014592 (entitled COLOR SLIDER, AND METHOD AND APPARATUS FOR MANUFACTURING IT).

The method of this technique included the steps of: disposing a pair of supporting tape in a molding die, the molding die having a plurality of meshing teeth forming slots (tape disposing step); heating and injecting the molding materials of two or more different colors in a separated and isolated manner after receipt of them from a raw material supply part (molding material heating and injecting step); separating an out side molding material carrying path (which extends from the molding material supply part to the sprue hole) into two or more paths so as to send the molding materials of two or more colors in a separated and isolated manner (material carrying step); separating the internal carrying passage (which extends from a plurality of the sprue holes to the meshing teeth forming slots)into two or more passages to inject the molding materials of different colors into the meshing teeth forming slots (injecting step); and cooling the meshing teeth of the supporting tape, and detaching the product.

This prior disclosure of the present inventor presented a possibility that the multi-color slide fastener can be produced. However, if the multi-color slide fastener can be continuously produced, and if the mass-production is to be satisfactory, more researches are required.

That is, the meshing teeth have to be speedily produced, and the molding materials of different colors have to be injected with a sufficient pressure, so that the pitches of the unit meshing teeth can be precise, thereby preventing any defects. In order to achieve these features, more researches and developments had to be carried out.

### SUMMARY OF THE INVENTION

The present invention is intended to overcome the above described disadvantages of the conventional techniques. Further, the present invention is intended to complement the shortness of the prior patent of the present inventor.

Therefore it is an object of the present invention to provide an apparatus for manufacturing a multi-color slide fastener, in which a plurality of unit meshing teeth consist of at least two or more differently colored groups, and the patterns of the unit meshing teeth and the base fabric of the garment are continuously harmonized to each other, so as to improve the design aesthetics, and so as to improve the design liberty degree, thereby making it possible to manufacture the multi-color slide fastener practically and satisfactorily.

It is another object of the present invention to provide an apparatus for manufacturing a multi-color slide fastener, in which the differently colored molding materials are injected with a sufficient pressure, thereby preventing any molding defects, and producing a perfect multi-color slide fastener.

In achieving the above objects, the apparatus for manufacturing a multi-color slide fastener according to the present invention includes: a molding die consisting of upper and lower dies, and having sprue holes for injecting molding materials of different colors into the molding die from injecting passages, the injecting passages being formed in a plurality for the molding materials of different colors; a cylinder block consisting of a plurality of molding material supplying cylinders and a plurality of molding material injecting cylinders, for supplying and injecting the molding materials of different colors; a plurality of carrying screws respectively inserted into the plurality of the molding material supplying cylinders, for carrying the molding materials of different colors; a plurality of pistons respectively inserted into the molding material injecting cylinders, for injecting the molding materials of different colors; and an opening-closing means for intermittently opening-closing the respective discharge holes of the cylinder block to intermittently inject the molding materials of different colors.

Specifically, the apparatus for manufacturing a multi-color slide fastener according to the present invention includes: a molding die consisting of upper and lower dies, a plurality of unit meshing teeth forming slots being formed in a longitudinal direction thereof, a plurality of molding material injecting passages being mutually isolatedly formed to inject the molding materials of different colors into respective groups of the meshing teeth forming slots, and a plurality of sprue holes being formed for injecting the molding materials of different colors into the respective molding material injecting passages; a cylinder block coupled to the top of the molding die, and consisting of a plurality of vertical cylinders and a plurality of horizontal cylinders in a crossing form, a plurality of discharge holes being formed correspondingly with the sprue holes of the upper die to communicate to the horizontal cylinders; a heating means for heating the cylinder block; a plurality of carrying screws respectively inserted into the vertical cylinders to carry the molding materials of different colors; a driving means for driving the carrying screws; a plurality of pistons respectively inserted into the horizontal cylinders, for extruding the molding materials; another driving means for driving the pistons; and an opening-closing means for intermittently opening-closing the respective discharge holes of the cylinder block to intermittently inject the molding materials of different colors.

### BRIEF DESCRIPTION OF THE DRAWINGS

The above objects and other advantages of the present invention will become more apparent by describing in detail the preferred embodiments of the present invention with reference to the attached drawings in which:

FIG. 1 is a longitudinal sectional view showing the general apparatus for manufacturing a single color slide fastener;

FIGS. 2 and 3 illustrate the molded form of the general single color slide fastener;

FIGS. 4 and 5 illustrate the manufacturing procedure in the conventionally proposed multi-color slide fastener manufacturing apparatus;

FIG. 6 is a plan view showing the design conception for applying the slide fastener to other products;

FIG. 7 is a perspective view of the multi-color slide fastener according to the present invention;

FIG. 8 illustrates a part of the multi-color slide fastener according to the present invention;

FIG. 9 illustrates various patterns of the multi-color slide fastener according to the present invention;

FIGS. 10 to 23 illustrate the apparatus for manufacturing the multi-color slide fastener according to the present invention, in which

FIG. 10 is an exploded perspective view of the multi-color slide fastener manufacturing apparatus according to the present invention;

FIG. 11 is a perspective view of a lower die;

FIG. 12 is an exploded perspective view of upper and lower dies;

FIG. 13 is an exploded perspective view of the upper and lower dies and a third cylinder plate;

FIG. 14 is an exploded perspective view of the multi-color slide fastener manufacturing apparatus according to the present invention;

FIG. 15 is a perspective view showing the constitution of the upper portion of the lower die;

FIGS. 16 and 17 are respectively a widthwise longitudinal sectional view and a lengthwise longitudinal sectional view showing a separated form of the dies;

FIG. 18 is a sectional view showing a state in which the molding material is filled into the inner passage of a cylinder block;

FIGS. 19 and 20 are respectively a widthwise longitudinal sectional view and a lengthwise longitudinal sectional view showing a state in which the dies are coupled together, and the molding material is filled into the cavity of the dies;

FIG. 21 is an enlarged view of the critical part of FIG. 19;

FIG. 22 is a partial perspective view of a completed product; and

FIG. 23 is a perspective view of the multi-color slide fastener thus manufactured; and

FIG. 24 is a longitudinal sectional view showing another embodiment of the apparatus for manufacturing the multi-color slide fastener according to the present invention.

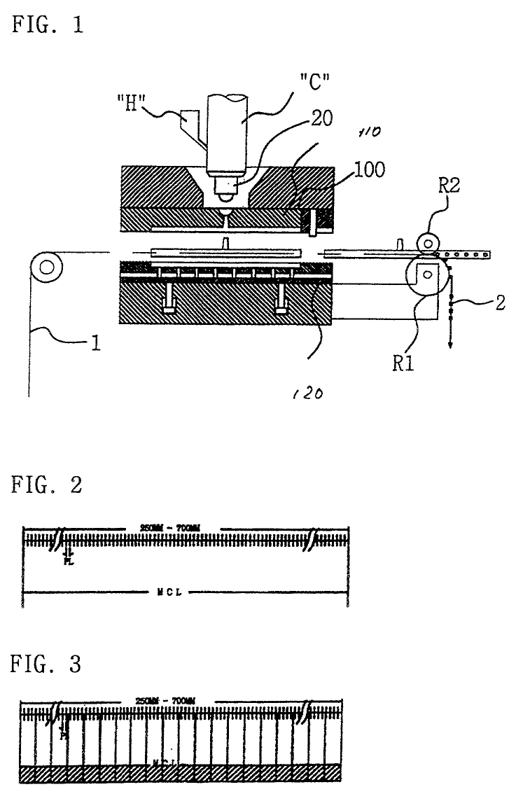

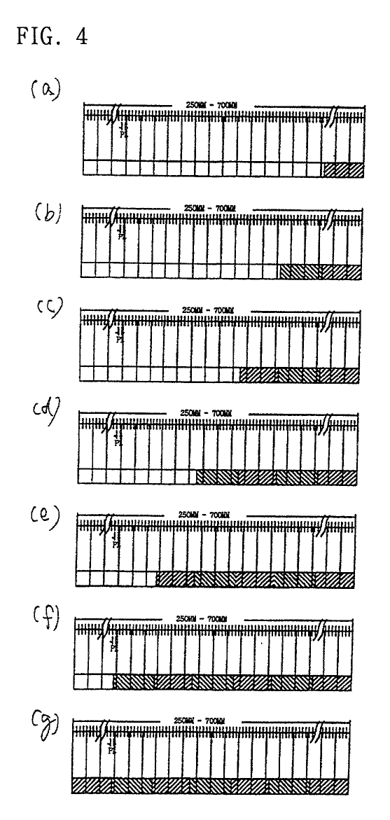

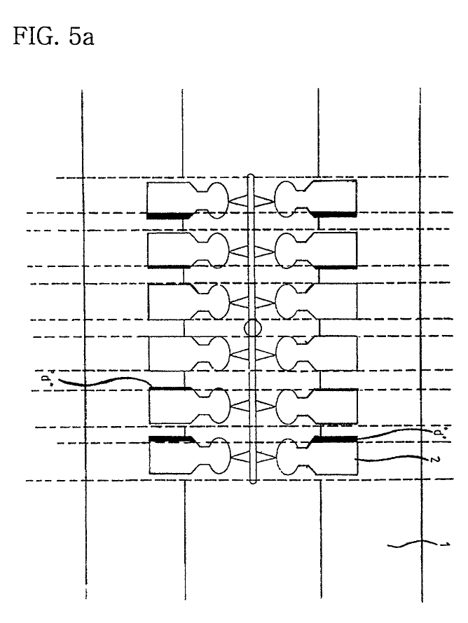

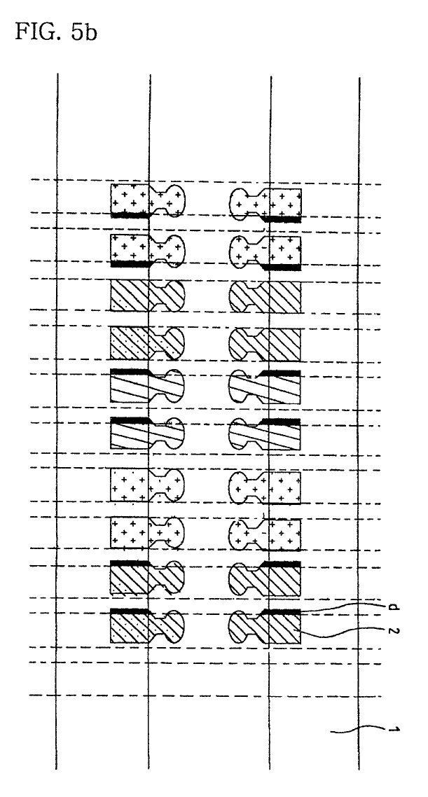

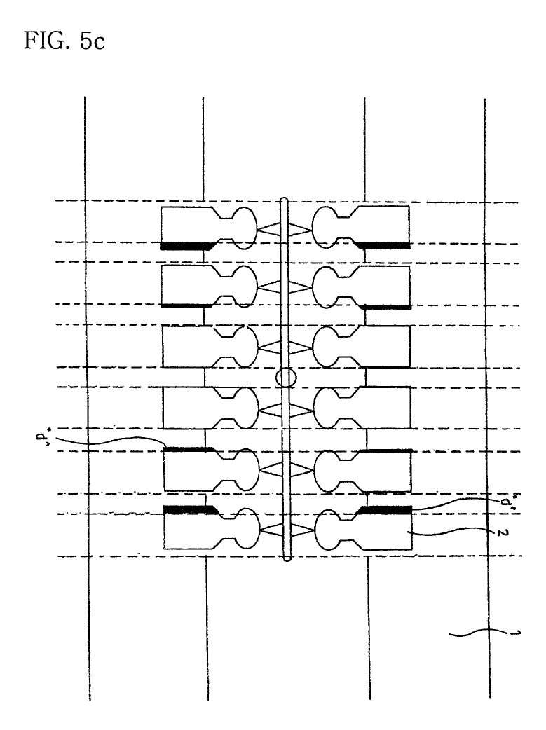

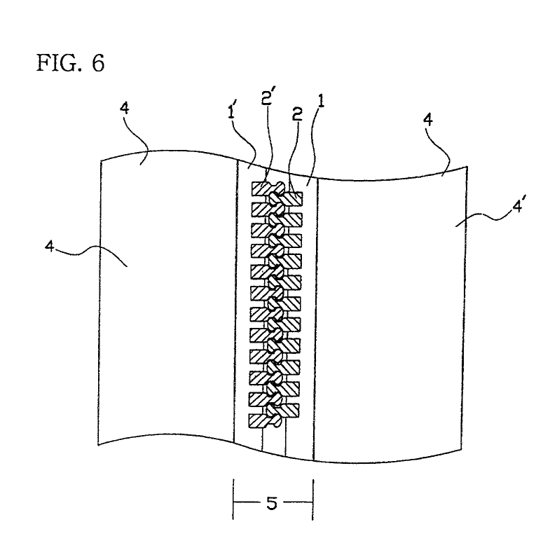

### DETAILED DESCRIPTION THE PREFERRED EMBODIMENTS

The preferred embodiments of the present invention will be described in detail referring to the attached drawings.

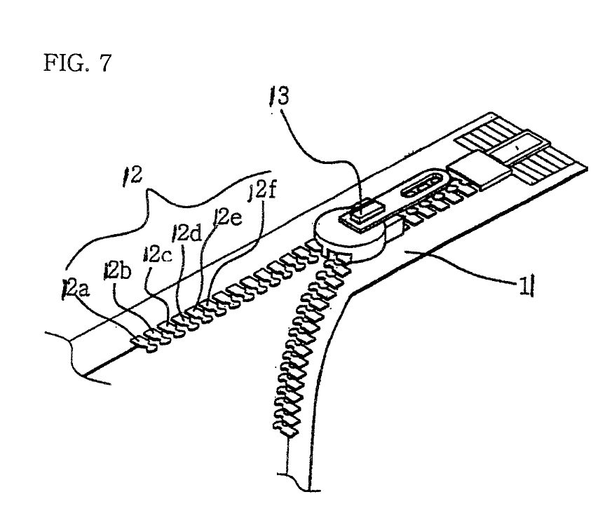

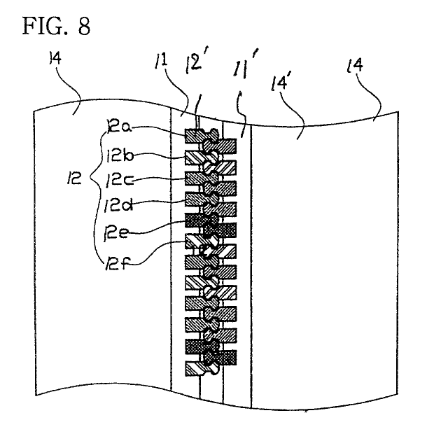

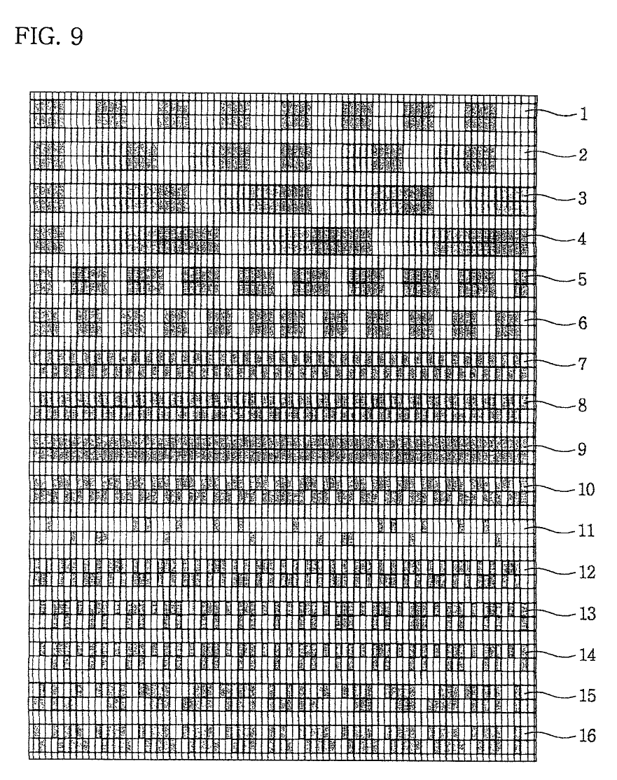

FIG. 7 is a perspective view of the multi-color slide fastener according to the present invention. FIG. 8 illustrates a part of the multi-color slide fastener according to the present invention. FIG. 9 illustrates various patterns of the multi-color slide fastener according to the present invention.

As shown in FIGS. 7 and 8, the multi-color slide fastener according to the present invention includes: a pair of supporting tapes 11; a plurality of unit meshing teeth 12 formed on the supporting tapes along the lengthwise direction of them, and consisting of two or more differently colored groups; and a slider 13 for coupling or separating the unit meshing teeth 12.

The plurality of the unit meshing teeth 12 (12a, 12b, 12c, 12d, 12e and 12f) can have different colors or can have combinations of different colors.

For example, the multi-color slide fastener, which is manufactured in the present invention, has 16 patterns, the patterns being regular or irregular.

Referring to FIGs. 8 and 9, in the multi-color slide fastener of the present invention, the pattern 14′ of a garment base fabric 14 is similar to and harmonized with the pattern 11′ of the supporting tapes 14 and/or the pattern 12′ of the unit meshing teeth 12.

In other words, if the pattern 14′ of the garment base fabric 14 is flowers, then the patterns 11′ and 12′ of the supporting tapes 11 and the unit meshing teeth 12 are continuously similar to flowers.

If the pattern 14′ of the garment base fabric 14 is crosschecks, then the patterns 11′ and 12′ of the supporting tapes 11 and the unit meshing teeth 12 are continuously similar to crosschecks. That is, the pattern 14′ of the garment base fabric 14 is similar to the patterns 11′ and 12′ of the supporting tapes 11 and the unit meshing teeth 12.

Further, the slider 13 which couples or separates the unit meshing teeth 12 can be made harmonic to the patterns 14′ , 11′ and 12′ of the garment base fabric 14, the supporting tapes 11 and the unit meshing teeth 12. The patterns 14′ , 11′ and 12′ can be made continuously harmonic to each other.

Further, the respective unit meshing teeth 12 can be made irregularly arranged, or regularly arranged so as to have to a regular pattern.

The supporting tapes 11 may be made of a fabric, or made of leather, or a synthetic resin. The meshing teeth 12 may be made of a synthetic resin or a metal such as aluminum, and further, may be made color-alterable depending on temperature or irradiation of visible light.

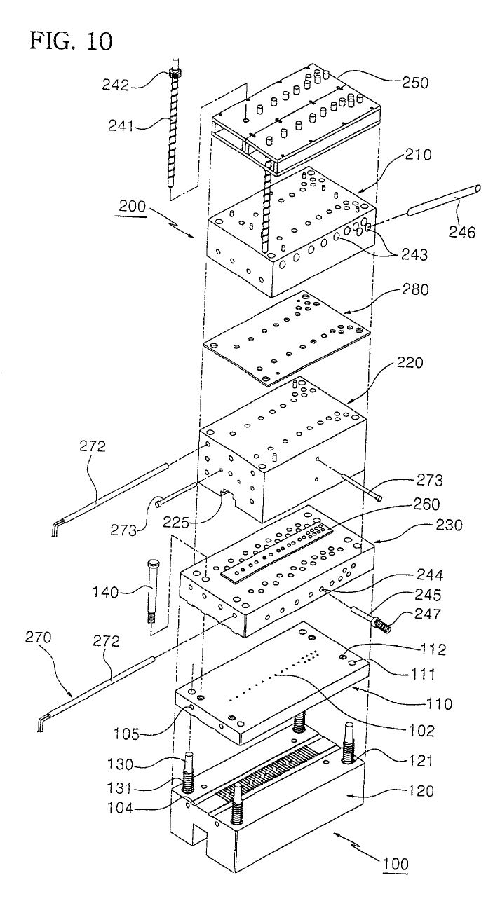

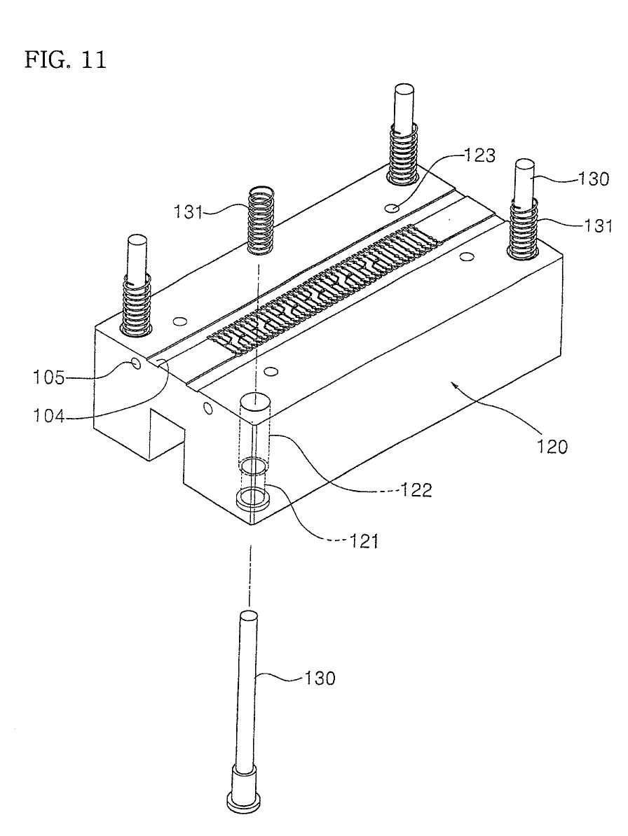

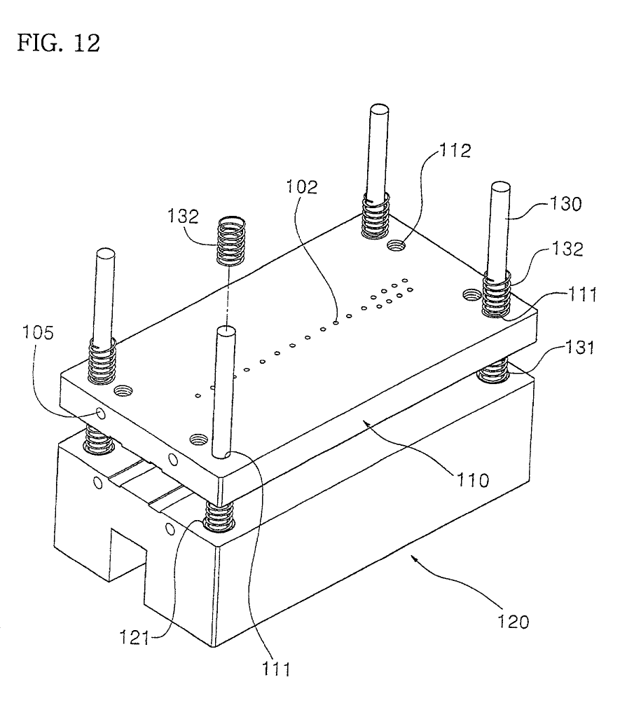

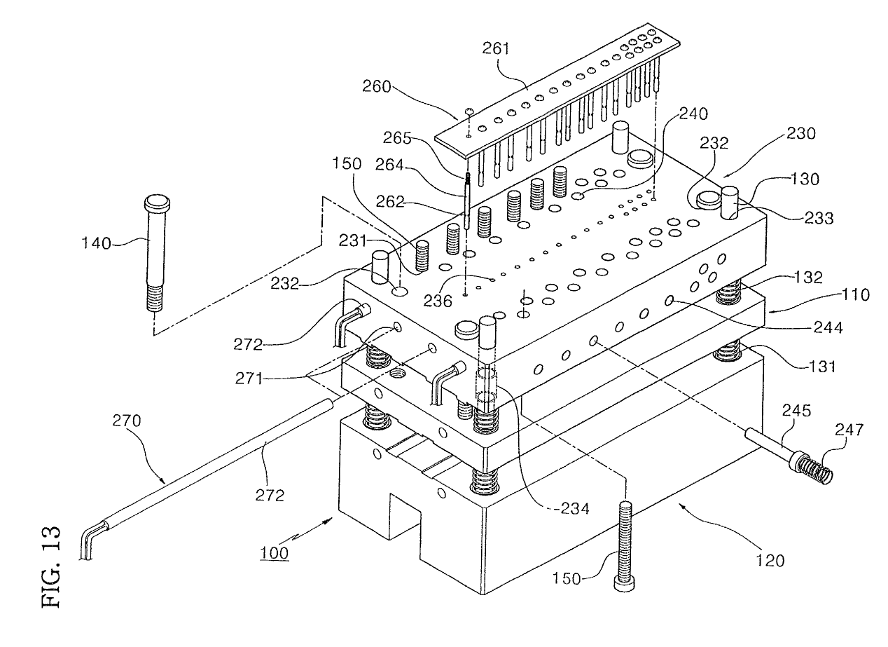

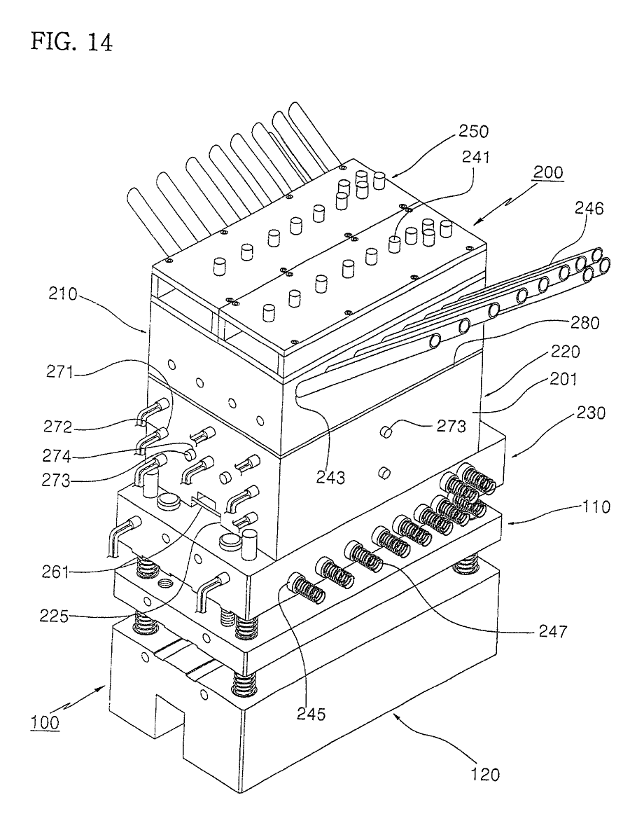

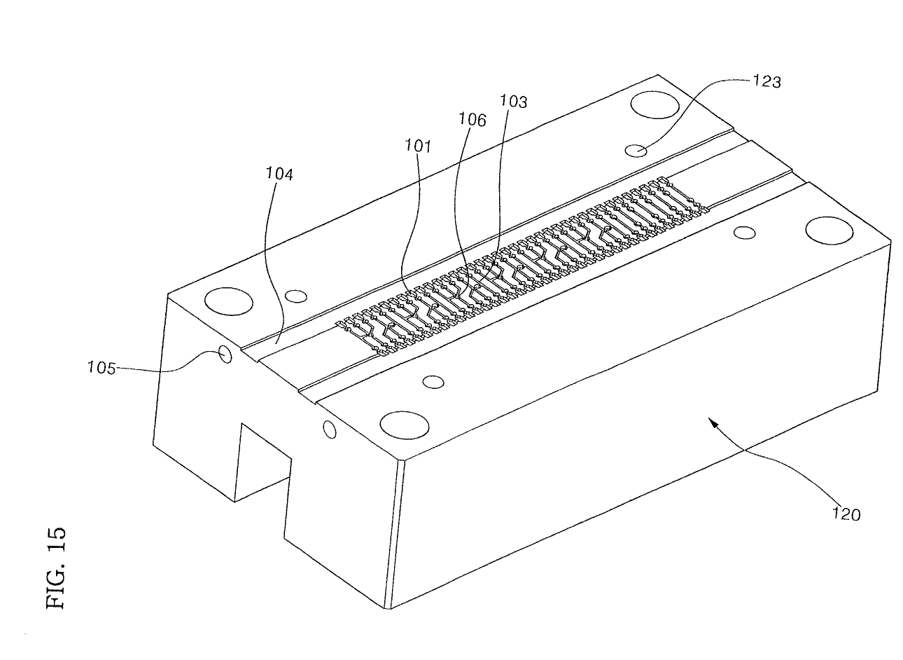

FIGS. 10 to 23 illustrate the apparatus for manufacturing the multi-color slide fastener according to the present invention. FIG. 10 is an exploded perspective view of the multi-color slide fastener manufacturing apparatus according to the present invention. FIG. 11 is a perspective view of a lower die. FIG. 12 is an exploded perspective view of upper and lower dies. FIG. 13 is an exploded perspective view of the upper and lower dies and a third cylinder plate. FIG. 14 is an exploded perspective view of the multi-color slide fastener manufacturing apparatus according to the present invention. FIG. 15 is a perspective view showing the constitution of the upper portion of the lower die.

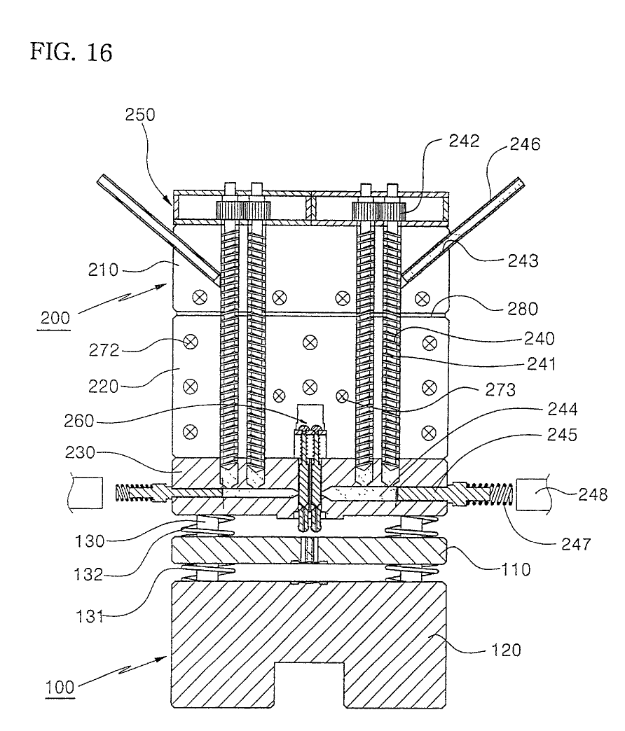

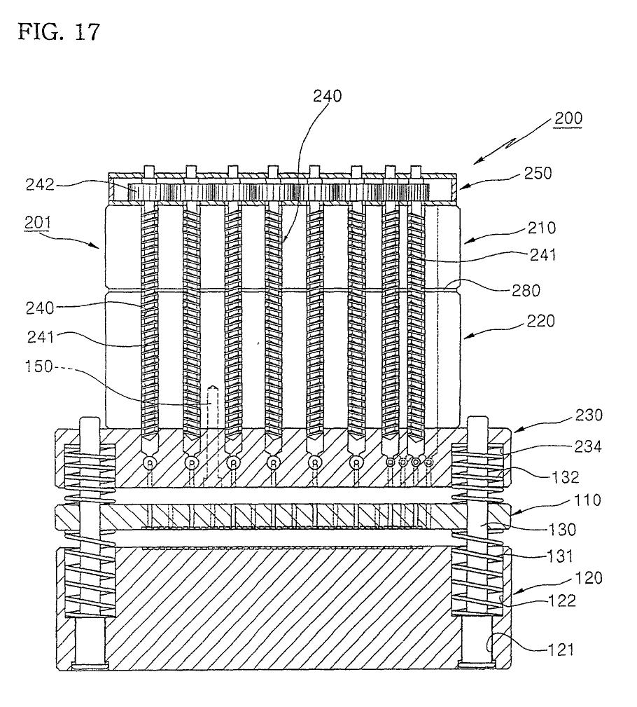

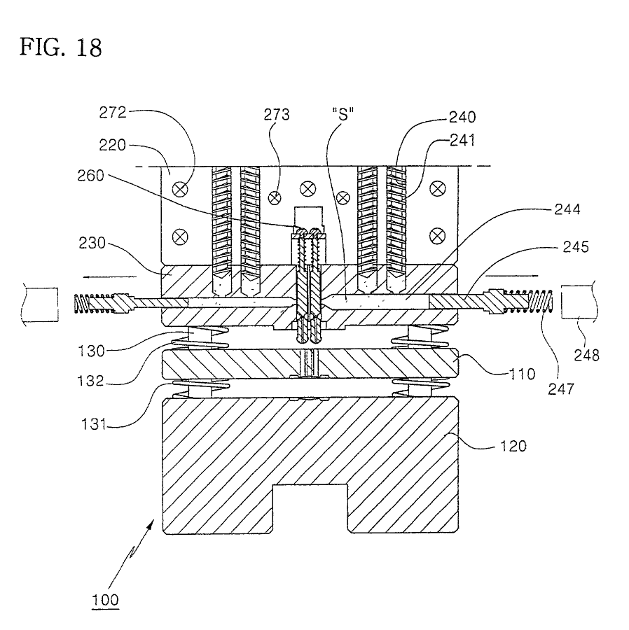

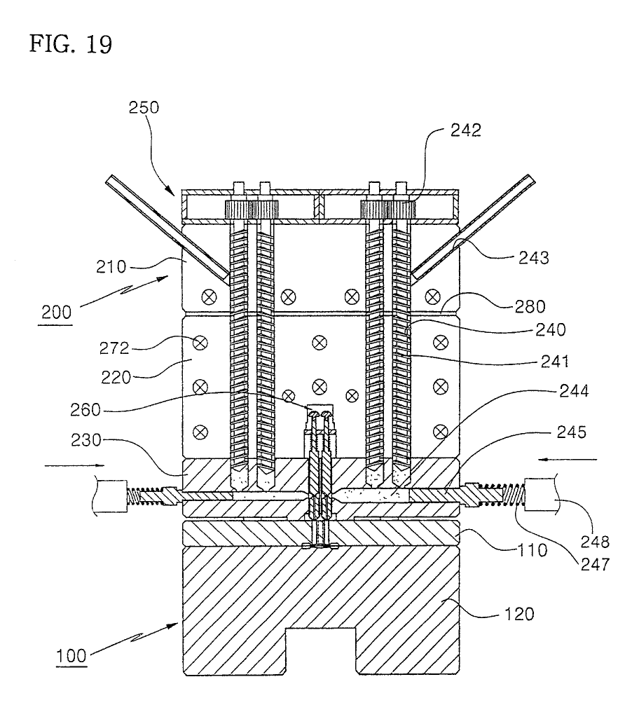

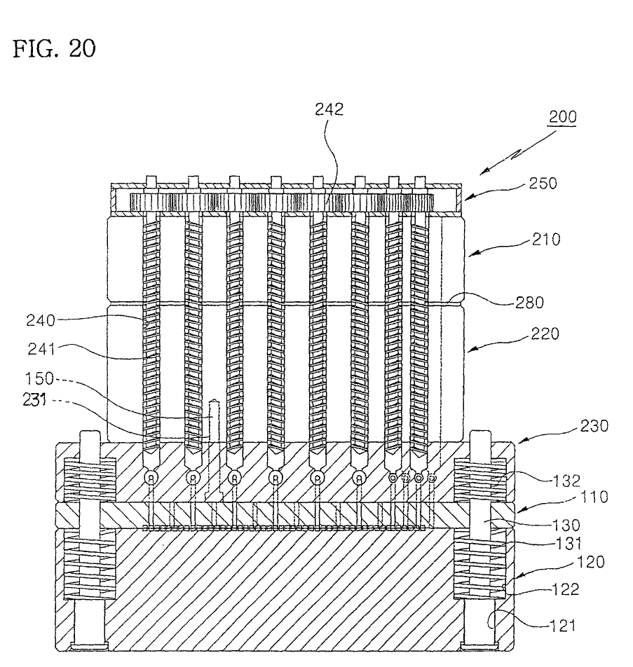

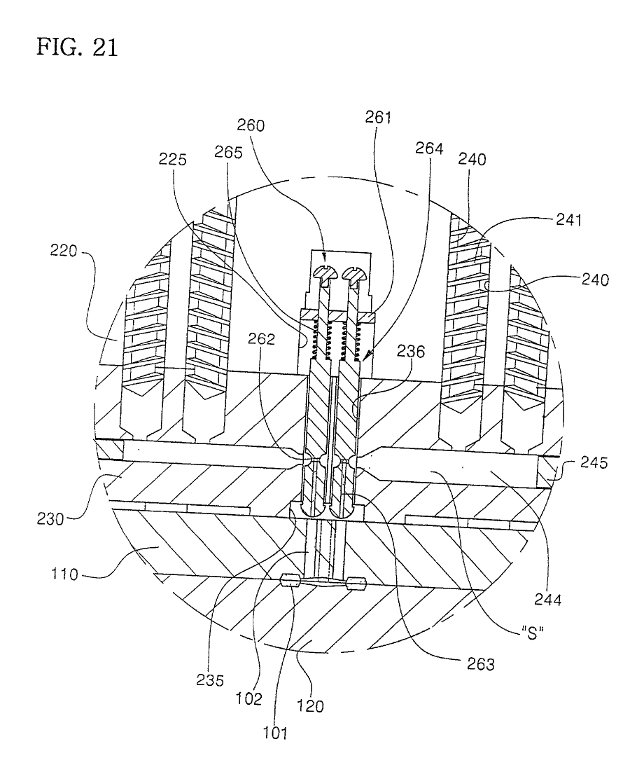

FIGS. 16 and 17 are respectively a widthwise longitudinal sectional view and a lengthwise longitudinal sectional view showing the separated form of the dies. FIG. 18 is a sectional view showing a state in which the molding material is filled into the inner passage of a cylinder block. FIGS. 19 and 20 are respectively a widthwise longitudinal sectional view and a lengthwise longitudinal sectional view showing a state in which the dies are coupled together, and the molding material is filled into the cavity of the dies. FIG. 21 is an enlarged view of the critical part of FIG. 19.

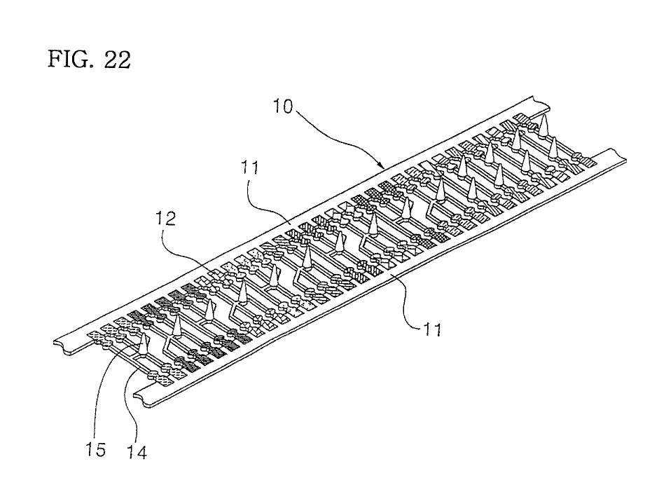

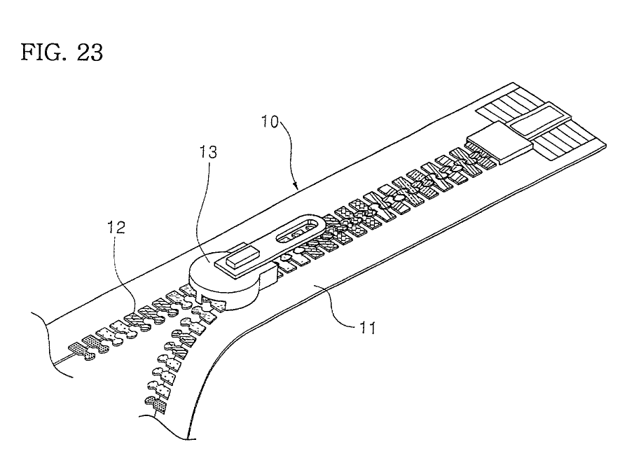

FIG. 22 is a perspective view of a completed product. FIG. 23 is a perspective view of the multi-color slide fastener thus manufactured.

As illustrated in the above drawings, the first preferred embodiment of the apparatus for manufacturing a multi-color slide fastener according to the present invention is constituted as follows.

That is, it includes a die 100 and a molding material injecting means 200. In the die 100, a plurality of unit meshing teeth forming slots 101 are formed therein, and the unit meshing teeth forming slots 101 are same as the unit meshing teeth 12 of FIG. 23 and same as those of FIGS. 15 and 10 to 12. The unit meshing teeth forming slots 101 are connected by connecting grooves 103 in each group, and the connecting grooves 103 are connected to sprue holes 102 to receive the molding materials of different colors.

The molding material injecting means 200 fills the melted molding materials S of different colors through the sprue holes 102 of the molding die 100 into the unit meshing teeth forming slots 101 of the molding die 100 as shown in FIGS. 10 and 14.

As shown in FIGS. 10 and 11, the die 100 consists of an upper die 110 and a lower die 120. As shown in FIGS. 15, 22 and 23, the upper and lower dies 110 and 120 include: a plurality of the unit meshing teeth forming slots 101 arranged in the lengthwise direction with predetermined gaps; and a pair of supporting tape passing channels 104 formed in the lengthwise direction for inserting the [air of the supporting tapes 11.

Further, each of the upper and lower dies 110 and 120 includes: a pair of cooling water passages 105 for rapidly cooling the relatively hot gel-phase molding materials S of different colors after filling of them into the unit meshing teeth forming slots 101.

In the lower die 120, depending on circumstance, a plurality of the unit meshing teeth forming slots 101 form a group by being connected by the connecting grooves 103. For example, 2 to 20 slots 101 form a group in which all the slots 101 are connected together by the connecting grooves 103. A sprue base 106 is connected to the connecting grooves 103 of each group.

The upper die 110 has sprue holes 102 correspondingly with the sprue base 106. The molding materials S of different colors are injected into the respective sprue holes 102, and thus, the molding materials S of different colors are injected respectively through the sprue bases 106 and the connecting grooves 103 into the respective groups of the unit meshing teeth forming slots 101, so that the unit meshing teeth 12 can be formed along the supporting tapes 11.

For example, the color arrangement can be formed in the following manner. That is, as shown in FIG. 15, two of the slots 101 of one side and three of the slots 101 of the other side are connected together through the connecting groove 103 to form a group, and three of the slots 101 of one side and two of the slots 101 of the other side are connected together through the connecting groove 103 to form another group, this being repeated, while the slots 101 are connected one to one through the connecting grooves 103 to form pairs in another region. Or other kinds of arrangements can be realized.

Further, in another case, the connecting grooves 103 may be eliminated in both the upper and lower dies 110 and 120. Thus the respective slots 101 may be made independent, and instead, the sprue holes 102 of the upper die 110 are directly connected to the slots 101.

Further, the sprue holes 102 of the upper die 110 can be formed in one train or two trains, and can be arranged in forms of zigzag, sinusoid or W, or can be arranged in a plurality of parallel skew lines.

The molding material injecting means 200 includes: a material inputting plate 210, a first cylinder plate 220 and a second cylinder plate 230, all of them being stacked together to form a cylinder block 201. Further, a gear box 250 is mounted upon the material inputting plate 210.

A plurality of vertical cylinders 240 are formed in the cylinder plates 220 and 230 so as to be matched with the sprue holes 102 of the upper die 110, while carrying screws 241 are inserted into the vertical cylinders 240 respectively.

Upon the carrying screws 241 which protrude above the material inputting plate 210, there are secured transmission gears 242 respectively, which are accommodated within the gear box 250 in a mutually meshed form. Further, the transmission gears 242 are connected to a driving gear (not illustrated) of a driving source such as a motor. Thus if the motor is driven, then all the transmission gears 242 are driven, so that the carrying screws 241 are rotated.

A plurality of molding material supply paths 243 are inclinedly formed on the material inputting plate 210 so as to supply the molding materials S of different colors, in such a manner that the molding material supply paths 243 are connected respectively to the plurality of the vertical cylinders 240. A pipe 246 is inserted into each of the molding material supply paths 243, and the pipe 246 is connected to a hopper (not illustrated), so that the molding materials S of different colors can be supplied.

A plurality of horizontal cylinders 244 are formed in the second cylinder plate 230, in such a manner that the cylinders 244 should be connected respectively to the vertical cylinders 240. A piston 245 is inserted into each of the horizontal cylinders 244, so that the molding materials can be pressingly pushed into the cylinder 244. On the outer end of each of the pistons 245, there is elastically installed a spring 247, so as to uniformly press the piston 245.

A plurality of opening-closing means 260 are formed within the first and second cylinder plates 220 and 230, so that the molding materials S of different colors can be intermittently injected from the horizontal cylinders 244 into the sprue holes 102 of the upper die 110.

As shown in FIGS. 10, 13, 14 and 21, each of the opening-closing means 260 is constituted as follows. That is, a supporting plate 261 is secured into an installation slot that is formed in a middle portion of the first cylinder plate 220 in the lengthwise direction. An opening-closing rod 264 is withdrawably inserted into each of discharge holes 236 which are formed in a middle portion of the second cylinder plate 230 in the lengthwise direction with certain gaps.

Each of the opening/closing rods 264 has an inlet 262 which communicates to the discharging end of the horizontal cylinder 244. Further, each of the rods 264 has a nozzle hole 263 which communicates to the sprue hole 102 of the upper die 110. The upper portion of each of the rods 264 is coupled to a supporting plate 261 through a spring 265.

A protecting step 235 is formed in a middle portion of the second cylinder plate 230 so as to protect each of the opening/closing rods 264 (FIG. 21).

A plurality of heating means 270 are installed in the molding material injecting means 200, for heating the molding materials S of different colors before injecting them into the molding die 100.

The heating means 270 are installed in the following manner That is, a plurality of insertion slots 271 are formed in the first and second cylinder plates 220 and 230, and rod type heaters 272 are inserted respectively into the plurality of the insertion slots 271. Further, a temperature sensor 273 such as thermocouple or the like is coupled to an insertion hole 274 which is formed in the first and second cylinder plates 220 and 230.

Further, as shown in FIGS. 10 and 14, a heat-insulating sheet 280 is disposed between the material inputting plate 210 and the first cylinder plate 220, so that the heat of the first cylinder plate 220 can be prevented from being conducted to the material inputting plate 210.

Meanwhile, the lower die 120 is fastened to a base plate of the apparatus by means of bolts. Further, the material inputting plate 210, the second cylinder plate 230 and the gear box 250 are fastened together to form a unitized structure, and this structure is coupled to a movable plate (not illustrated), in such a manner that the unitized structure can move up and down together with the movable plate.

This coupled structure for opening and closing the die can be easily devised in the general molding apparatus, and therefore, a detailed description on it will not be required. However, in order to make the understanding easier, a brief exemplary description will be presented below.

The lower die 120 has a guide hole 121 and a fastening hole 123 in each of its four corners. Thus the lower die 120 is fastened to the base plate of the apparatus by means of bolts, and the first cylinder plate 220 is secured to the movable plate, so that the first cylinder plate 220 can move up and down.

A plurality of fastening holes 231 are formed around the vertical cylinders 240 within the second cylinder plate 230, and thus, the second cylinder plate 230 is fastened to the first cylinder plate 220 by driving the bolts 150 through the fastening holes 231 into fastening holes 221 (FIG. 20).

Further, the second cylinder plate 230 has a coupling hole 232 and a guide hole 233 in each of its four corners, while the upper die 110 has a guide hole 111 and a coupling hole 112 in each of its four corners.

The second cylinder plate 230 is fastened to the upper die 110 by driving the bolts 140 through the coupling holes 232 into the coupling holes 112. Therefore, when the upper die 110 is opened from the lower die 120, the upper die 110 is suspended on the second cylinder plate 230 slightly separated from latter by the bolts 140.

Guide rods 130 are inserted through guide holes 121, 111 and 233 which are formed in the four corners of the lower die 120, the upper die 110 and the second cylinder plate 230. A spring 131 is inserted into a spring insertion slot 122 which is formed in each of the guide holes 121 of the lower die 120, so that the lower die 120 can elastically contact to the bottom of the upper die 110.

Further, a spring 132 is inserted into a spring insertion slot 234 which is formed in each of the guide holes 233 of the second cylinder plate 230, so that the second cylinder plate 230 can elastically contact to the top of the upper die 110.

Now the apparatus for manufacturing a multi-color slide fastener according to the present invention will be described as to its operations.

In this apparatus, the lower die 120 is coupled to the base plate of the apparatus, and the first cylinder plate 220 is coupled to the movable plate. The material inputting plate 210, the second cylinder plate 230 and the gear box 250 are fastened together to form a unitized structure, so that the unitized structure can move up and down together with the first cylinder plate 220.

The upper die 110 is coupled to between the second cylinder plate 230 and the base plate by means of the bolts 140, the guide rods 130 and the springs 131 and 132 in an openable/closable manner

After such an installation to realize the status of FIGS. 14, 16 and 17, the molding materials S of different colors are supplied through the hoppers into the pipes 246 of the molding material supply path 243.

Then the rod type heater 272 of the heating means 270 is used to heat the molding materials to a proper level, while the transmission gears 242 are driven. Thus the carrying screws 241 which are respectively inserted into the vertical cylinders 240 of the cylinder plates 220 and 230 are rotated to carry the molding materials S of different colors. Then the molding materials S of different colors are filled into the respective horizontal cylinders 244, with the result that the respective pistons 245 are pushed back as shown in FIG. 18 owing to the material injecting pressure.

Then the supporting tapes 11 are inserted into the tape insertion channels 104 of the lower die 120, and the movable plate is made to move down. Then the cylinder plates 220 and 230 and the gear box 250 move down, and the upper die 110 closely contacts to the lower die 120 by the elastic force of the springs 132, with the result that the supporting tapes 11 are tightly pressed within the tape insertion channels 104 and between the upper and lower dies 110 and 120.

Then the opening/closing rods 264 of the opening/closing means 260 of the first and second cylinder plates 220 and 230 are contacted to the sprue holes 102 of the upper die 110, and at the same time, move up against the forces of the springs 265, with the result that the inlets 262 of the opening/closing rods 264 are matched with the discharge holes of the horizontal cylinders 244. Thus open passages are formed through the nozzle holes 263 of the opening/closing rods 264 and the sprue holes 102 of the upper die 110. Then the bottom of the upper die 110 is contacted to the top of the lower die 120, and thus, the descending stops.

Thus the status of FIGS. 10 and 20 is realized. Under this condition, if the pistons 245 of the horizontal cylinders 244 are pushed in with a pressing means, then the molding materials S of different colors, which have been filled within the horizontal cylinders 244, are injected through the sprue holes 102 and the connecting grooves 103 into the unit meshing teeth forming slots 101.

The molding materials S of different colors are supplied into the vertical cylinders 240 of the cylinder plates 220 and 230 in accordance with the patterns and designs to be expressed, and therefore, the unit meshing teeth 12 of various colors are formed on the supporting tapes 11 by one shot injection molding.

The heating means 270 of the molding material injecting means 200 not only heats the molding materials of different colors within the vertical cylinders 240, but also maintains the temperature of the liquid or gel phase molding materials at a proper level, so that the molding materials S can smoothly flow from the vertical cylinders 240 to the unit meshing teeth forming slots 101.

Thereafter, the molding materials S of different colors, which have been filled into the unit meshing teeth forming slots 101, are cooled and cured to form the unit meshing teeth 12. Then the cylinder plates 220 and 230 and the gear box 250 are lifted, and the second cylinder plate 230 is separated from the upper die 120, while the upper die 120 is separated from the lower die 110.

Thereafter, the supporting tapes 11 on which a plurality of the unit meshing teeth 12 have been formed are detached from the die 100. Then the runner forming part 14 and the gate stick 15 are removed from the unit meshing teeth 12 as shown in FIG. 22, and a slider 13 is coupled as shown in FIG. 23. Thus a multi-color slide fastener in which an arbitrary pattern or design is expressed is completed.

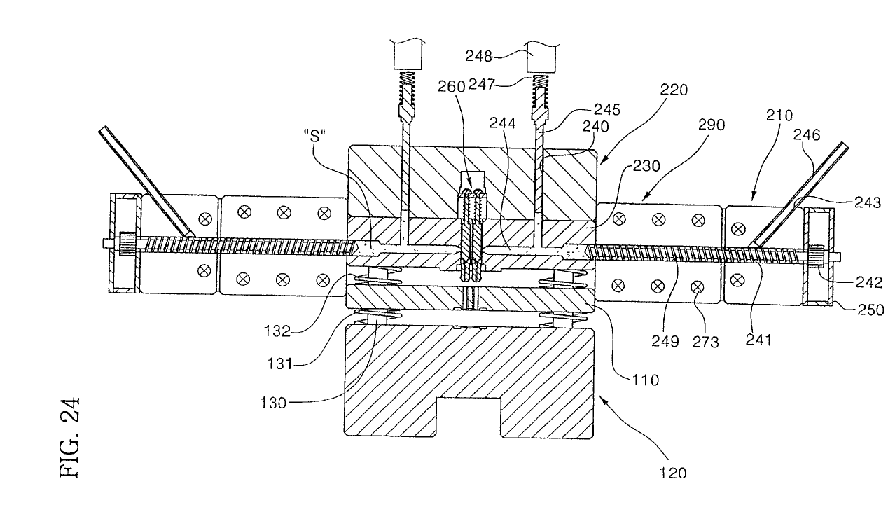

Meanwhile, FIG. 24 is a longitudinal sectional view showing another embodiment of the apparatus for manufacturing the multi-color slide fastener according to the present invention. In this second embodiment, the supply and injection structure has a form opposite to that of the first embodiment.

That is, in the first embodiment as described in FIGS. 10 to 23, the molding materials S of different colors are supplied into the vertical cylinders 240 to inject them into the sprue holes 102 of the die 100. In contrast to this, in the second embodiment, the molding materials S of different colors are supplied to the horizontal cylinders 244, and the pistons 245 are coupled to the vertical cylinders 240 to inject the molding materials.

Specifically in this second embodiment, the first and second cylinder plates 220 and 230 and the die 100 (110 and 120) are stacked in the middle, while on both sides of the second cylinder plate 230, there are attached a third cylinder plate 290, the material inputting plate 210 and the gear box 250.

Further, horizontal extension cylinders 249 which communicate to the horizontal cylinders 244 of the second cylinder plate 230 are formed in the third cylinder plate 290 and the material inputting plate 210. Further, screws 241 are respectively inserted into the horizontal extension cylinders 249. Further, pistons 245 are inserted into the vertical cylinders 240 which are formed in the first and second cylinder plates 220 and 230. Except the above-described features, other constitutions are similar to those of the first embodiment.

The operations of the second embodiment of the apparatus are similar to those of the first embodiment, and therefore, descriptions on them will be skipped here.

According to the present invention as described above, the multi-color slide fasteners can be continuously produced by injecting the molding materials of different colors into the meshing teeth forming slots of the molding die by one shot. That is, a plurality of groups of the meshing teeth are formed with different colors by one shot, so that the meshing teeth could form various patterns.

That is, one whole multi-color slide fastener can be manufactured by one shot, and therefore, the pitches and gaps between the unit meshing teeth are uniform. Accordingly, not only the multi-color slide fasteners can be mass-produced, but also their quality and reliability can be upgraded. Further, various patterns and colors can be formed on the slide fastener.

Further, when the multi-color slide fastener is installed to a garment or the like, any discontinuity of the pattern can be eliminated, and therefore, the aesthetics can be improved when installed in garments, bags and other personal articles.

Further, fluorescent materials can be used for the unit meshing teeth to form light emitting articles. Thus persons who work on the streets during nights can radiate a warning so as to be protected.

If this multi-color slide fastener is used in garments, bags, athletic uniforms, skiing uniforms, personal articles and the like, then such an expansion of application will create the demand, and will satisfy the consumer trend.

Further, the multi-color slide fastener can be easily manufactured at the existing factories, thereby saving a new additional investment.

Thus the multi-color slide fastener manufacturing apparatus is capable of manufacturing the multi-color slide fastener in a practical and satisfactory manner. Its production is not only fast but also its pitches are uniform, while the product defects are eliminated.

What is claimed is:

1. An apparatus for manufacturing a multi-color slide fastener, comprising:
a molding die 100 consisting of upper and lower dies 110 and 120, a plurality of unit meshing teeth forming slots 101 being formed in a longitudinal direction thereof, a plurality of molding material injecting passages being mutually isolatedly formed to inject the molding materials S of different colors into respective groups of the meshing teeth forming slots 101, and a plurality of sprue holes 102 being formed for injecting the molding materials S of different colors into the respective molding material injecting passages;
a cylinder block 201 coupled to a top of the molding die 100, and consisting of a plurality of vertical cylinders 240 and a plurality of horizontal cylinders 244 in a crossing form, a plurality of discharge holes 236 being formed correspondingly with the sprue holes 102 of the upper die 110 to communicate to the horizontal cylinders 244;
a heating means 270 for heating the cylinder block 201;
a plurality of carrying screws 241 respectively inserted into the vertical cylinders 240 to carry the molding materials S of different colors;
a driving means for driving the carrying screws 241;
a plurality of pistons 245 respectively inserted into the horizontal cylinders 244, for extruding the molding materials S;
another driving means for driving the pistons 245; and
an opening/closing means 260 for intermittently opening-closing the respective discharge holes 236 of the cylinder block 201 to intermittently inject the molding materials S of different colors.

2. An apparatus for manufacturing a multi-color slide fastener, comprising:
a molding die 100 consisting of upper and lower dies 110 and 120, a plurality of unit meshing teeth forming slots 101 being formed in a longitudinal direction thereof, a plurality of molding material injecting passages being mutually isolatedly formed to inject the molding materials S of different colors into respective groups of the meshing teeth forming slots 101, and a plurality of sprue holes 102 being formed for injecting the molding materials S of different colors into the respective molding material injecting passages;
a cylinder block 201 coupled to a top of the molding die 100, and consisting of a plurality of vertical cylinders 240 and a plurality of horizontal cylinders 244 in a crossing form, a plurality of discharge holes 236 being formed correspondingly with the sprue holes 102 of the upper die 110 to communicate to the horizontal cylinders 244;
a heating means 270 for heating the cylinder block 201;
a plurality of carrying screws 241 respectively inserted into the horizontal cylinders 244 to carry the molding materials S of different colors;
a driving means for driving the carrying screws 241;
a plurality of pistons 245 respectively inserted into the vertical cylinders 240, for extruding the molding materials S;
another driving means for driving the pistons 245; and
an opening/closing means 260 for intermittently opening-closing the respective discharge holes 236 of the cylinder block 201 to intermittently inject the molding materials S of different colors.

3. The apparatus as claimed in claim 1, wherein the cylinder block 201 comprises:
a material inputting plate 210, a first cylinder plate 220 and a second cylinder plate 230, all of them being stacked together;
a plurality of material supply paths 243 formed in the material inputting plate 210;
a plurality of discharge holes 236 and a plurality of the horizontal cylinders 244 formed in the second cylinder plate 230; and
a plurality of the vertical cylinders 240 formed in the material inputting plate 210, in the first cylinder plate 220 and in the second cylinder plate 230.

4. The apparatus as claimed in claim 1, wherein each of the opening-closing means 260 comprises:
a supporting plate 261 secured into an installation slot of a middle portion of the first cylinder plate 220 in the lengthwise direction;
an opening-closing rod 264 withdrawably inserted into each of discharge holes 236, the discharge holes 236 being formed in a middle portion of the second cylinder plate 230 in the lengthwise direction with certain gaps;
each of the opening/closing rods 264 having an inlet 262 to communicate to a discharging end of the horizontal cylinder 244, and each of the opening/closing rods 264 having a nozzle hole 263 to communicate to the sprue hole 102 of the upper die 110; and
an upper portion of each of the opening/closing rods 264 being coupled to a supporting plate 261 through a spring 265.

5. The apparatus as claimed in claim 1, wherein the carrying screws 241 inserted into the vertical cylinders 240 of the cylinder block 201 protrude above the gear box 250; and a plurality of transmission gears 242 are secured on upper portions of the carrying screws 241 and within the gear box 250.
